(19) United States
(12) Patent Application Publication
(10) Pub. No.: US 2022/0198536 A1
(43) Pub. Date: Jun. 23, 2022

(54) METHOD, INFORMATION PROCESSING APPARATUS, AND NON-TRANSITORY COMPUTER READABLE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(73) Assignee: TOYOTA JIDOSHA KABUSHIKI KAISHA, Toyota-shi (JP)

(21) Appl. No.: 17/552,133

(22) Filed: Dec. 15, 2021

(30) Foreign Application Priority Data
Dec. 18, 2020 (JP) 2020-210713

(51) Int. Cl. G06Q 30/02; G06Q 50/30; G06Q 30/04

(52) U.S. Cl. CPC G06Q 30/0284; G06Q 30/04; G06Q 50/30

(57) ABSTRACT

A method to be executed by an information processing apparatus includes billing a user of a vehicle parked in a space, storing first information indicating a status of payment of a bill amount by the user, and accepting access to the first information from a user account of an owner of the space.

### CROSS-REFERENCE TO RELATED APPLICATION

This application claims priority to Japanese Patent Application No. 2020-210713, filed on Dec. 18, 2020, the entire contents of which are incorporated herein by reference.

### TECHNICAL FIELD

The present disclosure relates to a method, an information processing apparatus, and a non-transitory computer readable medium.

### BACKGROUND

Technology related to the use of vehicle parking spaces is known. For example, patent literature (PTL) 1 discloses that users who report a nuisance vehicle improperly parked in a monthly parking lot are awarded points that can be used as partial payment of the parking fee.

### CITATION LIST

### Patent Literature

PTL 1: JP 2017-194820 A

### SUMMARY

There is room for improvement in technology related to the use of vehicle parking spaces.

It would be helpful to improve technology related to the use of vehicle parking spaces.

A method according to an embodiment of the present disclosure is a method to be executed by an information processing apparatus and includes:

billing a user of a vehicle parked in a space;

storing first information indicating a status of payment of a bill amount by the user; and

accepting access to the first information from a user account of an owner of the space.

An information processing apparatus according to an embodiment of the present disclosure includes a memory and a controller configured to:

bill a user of a vehicle parked in a space;

store first information indicating a status of payment of a bill amount by the user in the memory; and

accept access to the first information from a user account of an owner of the space.

A non-transitory computer readable medium according to an embodiment of the present disclosure stores a program configured to cause a computer to execute operations, the operations including:

billing a user of a vehicle parked in a space;

storing first information indicating a status of payment of a bill amount by the user; and

accepting access to the first information from a user account of an owner of the space.

According to an embodiment of the present disclosure, technology related to the use of vehicle parking spaces is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of an information processing apparatus;

FIG. 4 is a block diagram illustrating a schematic configuration of a terminal apparatus; and

FIG. 5 is a flowchart illustrating operations of the information processing apparatus.

### DETAILED DESCRIPTION

Hereinafter, an embodiment of the present disclosure will be described.

### Outline of Embodiment

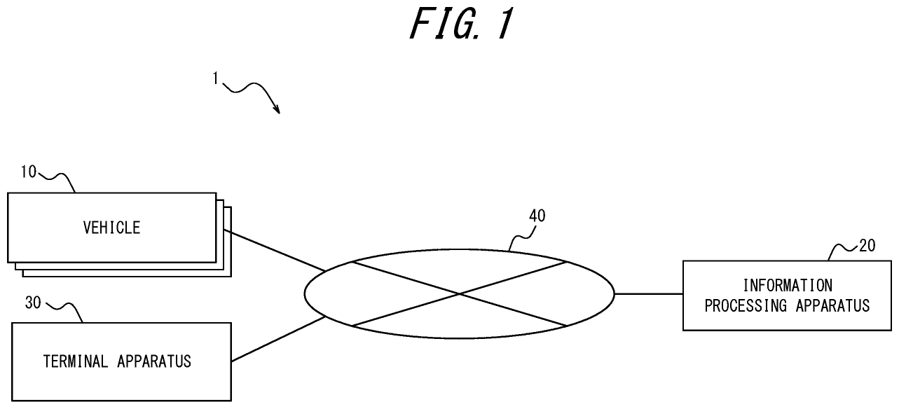

An outline of a system 1 according to an embodiment of the present disclosure will be described with reference to FIG. 1. The system 1 includes a vehicle 10, an information processing apparatus 20, and a terminal apparatus 30. The vehicle 10, the information processing apparatus 20, and the terminal apparatus 30 are communicably connected to a network 40 including, for example, the Internet, a mobile communication network, and the like.

The vehicle 10 is an automobile, for example, but is not limited to this, and may be any appropriate vehicle. The vehicle 10 may be driven by a driver. The vehicle 10 may be capable of automated driving such as any one of Level 1 to Level 5 as defined by the Society of Automotive Engineers (SAE), for example. The number of vehicles 10 provided in the system 1 may be freely determined. A user of the vehicle 10 may be a driver who performs driving operations on board the vehicle 10 or remotely, or may be an occupant or passenger of the vehicle 10. The user of the vehicle 10 may be the owner of the vehicle 10 or a borrower of the vehicle 10.

The information processing apparatus 20 is, for example, a server apparatus but is not limited to this and may be any appropriate computer. The information processing apparatus 20 can communicate with the vehicle 10 and the terminal apparatus 30 via the network 40.

The terminal apparatus 30 is, for example, an apparatus used by the owner of a space, such as private property. For example, a communication apparatus such as a mobile phone, a smartphone, a tablet terminal, or a personal computer (PC) may be used as the terminal apparatus 30. The owner of the space can use the terminal apparatus 30 to log into their own user account and register information on the owned space in the information processing apparatus 20. The owner's space can, for example, be registered as a paid parking area where parking fees are collected or as a no-parking area where fines are collected.

First, an outline of the present embodiment will be described, and details thereof will be described later. The information processing apparatus 20 bills the user of the vehicle 10 parked in the space. The information processing apparatus 20 stores information indicating the status of payment of the bill amount by the user (first information). The information processing apparatus 20 then accepts access to the first information from the user account of the owner of the space.

According to the present embodiment, the status of payment of the bill amount by the user of the vehicle 10 parked in the space is thus disclosed to the owner of the space. Accordingly, technology related to the use of a parking space for the vehicle 10 is improved in that the owner of the space can freely verify whether the bill amount has been properly paid by the user of the vehicle 10.

Next, configurations of the system 1 will be described in detail.

(Configuration of Vehicle)

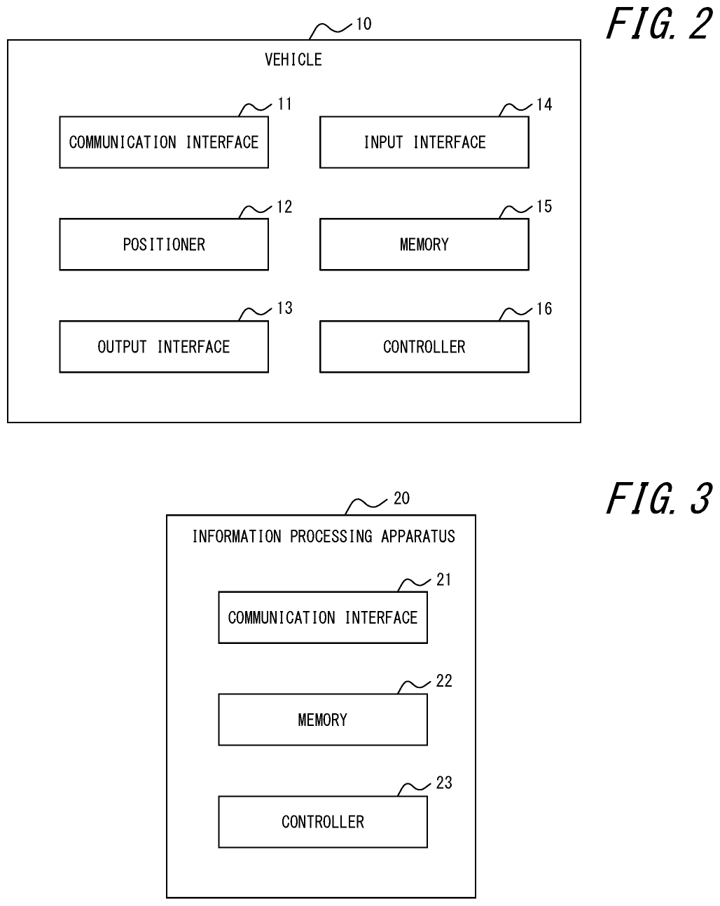

As illustrated in FIG. 2, the vehicle 10 includes a communication interface 11, a positioner 12, an output interface 13, an input interface 14, a memory 15, and a controller 16.

The communication interface 11 includes at least one communication interface for connecting to the network 40. The communication interface is compliant with mobile communication standards such as the 4th generation (4G) standard or the 5th generation (5G) standard, for example, but these examples are not limiting. In the present embodiment, the vehicle 10 communicates with the information processing apparatus 20 via the communication interface 11 and the network 40.

The positioner 12 includes one or more apparatuses configured to acquire positional information for the vehicle 10. Specifically, the positioner 12 includes, for example, a receiver compliant with GPS, but is not limited to this example and may include a receiver compliant with any appropriate satellite positioning system.

The output interface 13 includes at least one output device for outputting information to notify the user of the information. The output device is a display for outputting information as video, a speaker for outputting information as audio, or the like, for example, but is not limited to these. The display may be a panel display that outputs image as real images, or a head-up display that displays images as virtual images.

The input interface 14 includes at least one input device for detecting user input. The input device is a physical key, a capacitive key, a touchscreen integrally provided with a display of the output interface 13, a microphone for accepting audio input, a camera, or the like, for example, but is not limited to these.

The memory 15 includes one or more memories. The memories are semiconductor memories, magnetic memories, optical memories, or the like, for example, but are not limited to these. The memories included in the memory 15 may each function as, for example, a main memory, an auxiliary memory, or a cache memory. The memory 15 stores any information used for operations of the vehicle 10. For example, the memory 15 may store a system program, an application program, embedded software, and the like. The information stored in the memory 15 may be updated with, for example, information acquired from the network 40 via the communication interface 11.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire vehicle 10.

(Configuration of Information Processing Apparatus)

As illustrated in FIG. 3, the information processing apparatus 20 includes a communication interface 21, a memory 22, and a controller 23.

The communication interface 21 includes at least one communication interface for connecting to the network 40. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 via the communication interface 21 and the network 40.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 40 via the communication interface 21.

The controller 23 includes at least one processor, at least one programmable circuit, at least one dedicated circuit, or a combination of these. The controller 23 controls the operations of the entire information processing apparatus 20.

(Configuration of Terminal Apparatus)

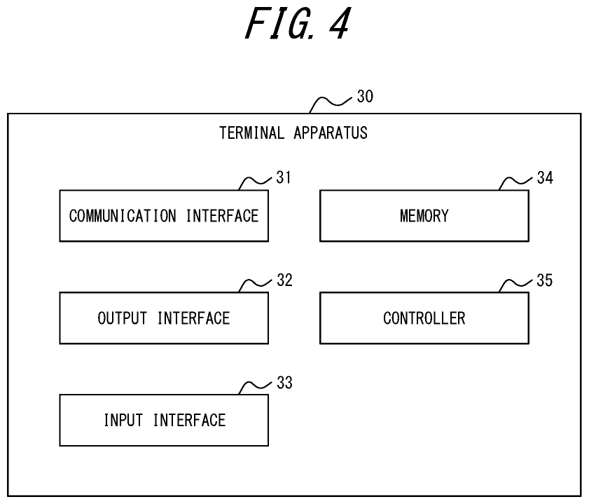

As illustrated in FIG. 4, the terminal apparatus 30 includes a communication interface 31, an output interface 32, an input interface 33, a memory 34, and a controller 35.

The communication interface 31 includes one or more communication modules to connect to the network 40. The communication module is compliant with a mobile communication standard, a wired LAN standard, or a wireless LAN standard, for example, but is not limited to these, and may be compliant with any communication standard. In the present embodiment, the terminal apparatus 30 communicates with the information processing apparatus 20 via the communication interface 31 and the network 40.

The output interface 32 includes at least one output device for outputting information to notify the user of the information. The output device is a display for outputting information as video, a speaker for outputting information as audio, or the like, for example, but is not limited to these.

The input interface 33 includes at least one input device for detecting user input. The input device is a physical key, a capacitive key, a touchscreen integrally provided with a display of the output interface 32, a microphone for accepting audio input, a camera, or the like, for example, but is not limited to these.

The memory 34 includes one or more memories. The memories included in the memory 34 may each function as, for example, a main memory, an auxiliary memory, or a cache memory. The memory 34 stores any information used for operations of the terminal apparatus 30. For example, the memory 34 may store a system program, an application program, and the like. The information stored in the memory 34 may be updated with, for example, information acquired from the network 40 via the communication interface 31.

The controller 35 includes at least one processor, at least one programmable circuit, at least one dedicated circuit, or a combination of these. The controller 35 controls the operations of the entire terminal apparatus 30.

(Flow of Operations of Information Processing Apparatus)

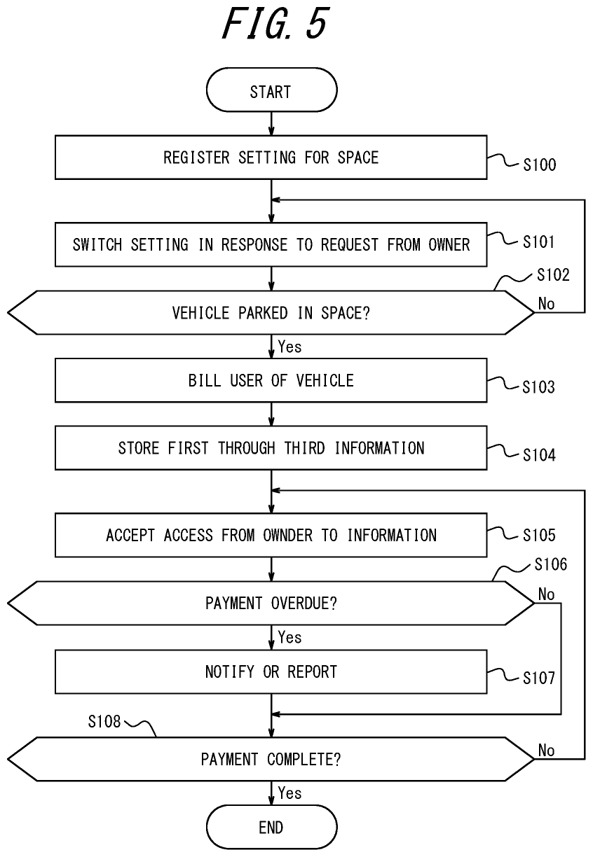

Operations of the information processing apparatus 20 according to the present embodiment will be described with reference to FIG. 5. In the following description, it is assumed that the terminal apparatus 30 is already logged into the user account of the owner of the space.

Step S100: The controller 23 of the information processing apparatus 20 registers, as a setting of the space, a first setting that permits parking by vehicles 10 in the space or a second setting that prohibits parking by vehicles 10 in the space.

Specifically, the controller 35 of the terminal apparatus 30 accepts, in response to an operation by the owner of the space, input of information regarding the space. For example, the information regarding the space includes, but is not limited to, positional information for the space. The controller 35 transmits the information regarding the space to the information processing apparatus 20. The controller 23 of the information processing apparatus 20 stores, in the memory 22, the information regarding the space received from the terminal apparatus 30. The controller 23 then registers the first setting or the second setting as the setting for the space by storing the first setting or the second setting in the memory 22. Here, the controller 23 may automatically select either the first setting or the second setting. Alternatively, either the first setting or the second setting may be designated in the information regarding the space received from the terminal apparatus 30. In this case, the controller 23 may register whichever one of the first setting and the second setting is designated.

If the setting for the space is the first setting, the space is used as a pay parking area where a parking fee is collected, for example. On the other hand, if the setting for the space is the second setting, the space is used as a no-parking area where a fine is collected, for example.

Step S101: The controller 23 switches the setting for the space from one of the first and second settings to the other in response to a request from a user account of the owner of the space.

Specifically, the controller 35 of the terminal apparatus 30 transmits a signal requesting a change in the setting for the space to the information processing apparatus 20 in response to an operation by the owner of the space. When the controller 23 of the information processing apparatus 20 receives the signal from the terminal apparatus 30, the controller 23 switches the setting for the space from one of the first and second settings to the other. According to this configuration, the owner of the space can switch the setting for the space using the terminal apparatus 30. If the controller 23 has not received the signal from the terminal apparatus 30, the controller 23 does not execute the operation of step S101. In other words, the operation of step S101 is performed when the information processing apparatus 20 receives the signal from the terminal apparatus 30.

Step S102: the controller 23 determines whether a vehicle 10 has parked in the space. When it is determined that a vehicle 10 has parked in the space (step S102: Yes), the process advances to step S103. Conversely, when it is determined that a vehicle 10 is not parked in the space (step S102: No), the process returns to step S101.

Specifically, the controller 23 receives positional information from each vehicle 10 in a plurality of vehicles 10. The controller 23 determines whether a vehicle 10 has parked in the space based on the positional information of each vehicle 10 and the positional information of the space. Any method can be used to determine whether the vehicle 10 has parked in the space. For example, the controller 23 may determine that a vehicle 10 has parked in the space when the positional information for the vehicle 10 and the positional information for the space continue to substantially match for a predetermined length of time. As another example, when the controller 23 receives information indicating that a vehicle 10 has parked (such as a signal indicating a power off state or information indicating that the gear shift is in park) from the vehicle 10 while the positional information for the vehicle 10 and the positional information for the space substantially match, the controller 23 may determine that the vehicle 10 has parked in the space.

Step S103: When it is determined in step S102 that the vehicle 10 is parked in the space (step S102: Yes), the controller 23 bills the user of the vehicle 10 parked in the space.

Any method can be used to bill the user. For example, the memory 22 may store payment information for the user of each vehicle 10 in advance. The payment information may include account information, credit card information, or the like, but is not limited to these examples. The controller 23 may request that a server of a bank, a credit card company, or the like perform a billing process for the user based on the payment information for the user of the vehicle 10 parked in the space. Alternatively, the controller 23 may request that the user pay the bill amount. Specifically, the controller 23 may transmit information requesting payment of the bill amount to, for example, the vehicle 10, a communication device such as a smartphone used by the user, or an email address of the user.

Here, the bill amount for the user may differ depending on whether the setting for the space is the first setting or the second setting. As described above, when the setting for the space is the first setting, the space is used as a paid parking area. Hence, the bill amount for the user may be the amount of the parking fee. The amount of the parking fee may be an amount designated from the user account of the owner of the space or may be a predetermined amount. On the other hand, when the setting for the space is the second setting, the space is used as a no-parking area. Hence, the bill amount for the user may be the amount of the fine. The bill amount for the user may be higher when the setting for the space is the second setting than when the setting for the space is the first setting.

At least a portion of the amount paid by the user of the vehicle 10 may be transferred to an account designated from the user account of the owner of the space, or to an account of the business that manages the information processing apparatus 20.

Step S104: The controller 23 stores the first information, the second information, and the third information in the memory 22.

The first information is information indicating the payment status of the bill amount by the user who was billed in step S103. For example, the first information indicates, but is not limited to, whether payment of the bill amount by the user is complete. The controller 23 may, for example, receive the first information from a server, such as a bank or a credit card company that is requested to implement the billing process, and store the first information in the memory 22.

The second information is information regarding the record of parking by the user in any space where parking is prohibited. For example, the second information indicates, but is not limited to, the date and time, number of times, and frequency that the user has parked in a space with the second setting, a space where parking is prohibited by law, or the like. The controller 23 may, for example, receive the second information from a server that monitors the record of parking by the user of each vehicle 10 and store the second information in the memory 22.

The third information is information regarding a record of payment by the user for the bill. For example, the third information may be, but is not limited to, the user's credit information. The controller 23 may, for example, receive the third information from a server of a credit card company and store the third information in the memory 22.

Here, the first information, the second information, and the third information stored in the memory 22 may be repeatedly updated in a predetermined cycle, for example, from step S104 onwards.

Step S105: The controller 23 accepts access to the first information, the second information, and the third information from the user account of the owner of the space.

Specifically, the controller 35 of the terminal apparatus 30 transmits a signal requesting access to the first information, the second information, and/or the third information to the information processing apparatus 20 in response to an operation by the owner of the space. When the controller 23 of the information processing apparatus 20 receives the signal from the terminal apparatus 30, the controller 23 transmits the requested information to the terminal apparatus 30. According to this configuration, the owner of the space can check the first information, the second information, and/or the third information using the terminal apparatus 30.

Step S106: The controller 23 determines whether payment of the bill amount by the user of the vehicle 10 is overdue. When it is determined that payment is overdue (S106: Yes), the process advances to step S107. Conversely, when it is determined that payment is not overdue (S106: No), the process advances to step S108.

Any method can be used to determine whether the payment of the bill amount by the user of the vehicle 10 is overdue. For example, the controller 23 may determine, based on the first information stored in the memory 22, whether payment of the bill amount by the user of the vehicle 10 has been incomplete for a predetermined period of time. When it is determined that payment has been incomplete for a predetermined period of time, the controller 23 may determine that the payment of the bill amount by the user of the vehicle 10 is overdue. Conversely, when it is determined that payment has not been incomplete for a predetermined period of time, the controller 23 may determine that the payment of the bill amount by the user of the vehicle 10 is not overdue.

Step S107: when it is determined in step S106 that the payment is overdue (step S106: Yes), the controller 23 notifies the owner of the space, notifies the user of the vehicle 10, and/or reports to the police.

Specifically, the controller 23 may notify the owner of the space that payment of the bill amount by the user of the vehicle 10 parked in the space is overdue. Any method can be used to notify the owner of the space of the information. For example, the controller 23 may transmit the information to the user account or email address of the owner of the space.

Specifically, the controller 23 may notify the user of the vehicle 10 that the payment of the bill amount is overdue. Any method can be used to notify the user of the vehicle 10 of the information. For example, the controller 23 may transmit the information to the vehicle 10, a communication device such as a smartphone used by the user, or an email address of the user.

Specifically, the controller 23 may report to the police that payment of the bill amount by the user of the vehicle 10 parked in the space is overdue. Any method can be used to report to the police. For example, the controller 23 may report to the police by transmitting information to a server managed by the police.

Step S108: The controller 23 determines, based on the first information stored in the memory 22, whether payment of the bill amount by the user of the vehicle 10 is complete. When it is determined that payment is complete (step S108: Yes), the process ends. Conversely, when it is determined that payment is incomplete (S108: No), the process returns to step S105.

As described above, the information processing apparatus 20 according to the present embodiment bills the user of the vehicle 10 parked in a space. The information processing apparatus 20 stores the first information indicating the status of payment of the bill amount by the user. The information processing apparatus 20 then accepts access to the first information from the user account of the owner of the space.

According to this configuration, the status of the payment of the bill amount by the user of the vehicle 10 parked in the space is disclosed to the owner of the space. Accordingly, technology related to the use of a parking space for the vehicle 10 is improved in that the owner of the space can freely verify whether the bill amount has been properly paid by the user of the vehicle 10.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the configuration and operations of the information processing apparatus 20 in the above embodiment may be distributed to a plurality of computers capable of communicating with each other. For example, some or all of the components of the information processing apparatus 20 may be provided in the terminal apparatus 30.

For example, in the above embodiment, the information processing apparatus 20 has been described as storing the second information and the third information in step S104. However, the information processing apparatus 20 can also be configured to store the second information and the third information when payment of the bill amount by the user of the vehicle 10 parked in the space is overdue. Specifically, the controller 23 of the information processing apparatus 20 stores only the first information in the memory 22 in step S104. If the controller 23 determines that the payment is overdue in step S106, the controller 23 stores the second information and the third information in the memory 22. As described above, the second information is information regarding the record of parking by the user of the vehicle 10, and the third information is information regarding the record of payment by the user for bills. Since the second information and the third information are personal information on the user, or information similar to personal information, such information is preferably not disclosed unnecessarily from the standpoint of privacy protection. In contrast, according to the above configuration, the second information and the third information are not disclosed to the owner of the space when payment of the bill amount by the user of the vehicle 10 is not overdue. The privacy of the user of the vehicle 10 can thereby be protected.

For example, the information processing apparatus 20 can also be configured to store the second information and the third information on the condition that the setting for the space is the second setting. Specifically, the controller 23 of the information processing apparatus 20 may store the second information and the third information in step S104 when the setting for the space is the second setting. Alternatively, the controller 23 may store the second information and the third information in the memory 22 when the setting for the space is the second setting and the payment is determined to be overdue in step S106. As described above, when the setting of the space is the second setting, the space is used as a no-parking area. According to the above configuration, the second information and the third information are disclosed to the owner of the space only when the user of the vehicle 10 improperly parks in a space that is a no-parking area. The privacy of the user of the vehicle 10 can thereby be protected.

For example, an embodiment in which a general purpose computer functions as the information processing apparatus 20 or the terminal apparatus 30 according to the above embodiment can also be implemented. Specifically, a program in which processes for realizing the functions of the information processing apparatus 20 or the terminal apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method to be executed by an information processing apparatus, the method comprising:
billing a user of a vehicle parked in a space;
storing first information indicating a status of payment of a bill amount by the user; and
accepting access to the first information from a user account of an owner of the space.

2. The method of claim 1, further comprising:
determining, based on the first information, whether payment of the bill amount by the user is overdue; and
notifying the owner, notifying the user, and/or reporting to police when the payment of the bill amount by the user is determined to be overdue.

3. The method of claim 1, further comprising registering, as a setting for the space, a first setting that permits parking in the space by vehicles, or a second setting that prohibits parking in the space by vehicles.

4. The method of claim 3, wherein the bill amount for the user differs depending on whether the setting for the space is the first setting or the second setting.

5. The method of claim 3, further comprising switching the setting for the space from one of the first setting and the second setting to the other in response to a request from the user account of the owner.

6. The method of claim 1, further comprising:
storing second information regarding a record of parking by the user in a space where parking is prohibited; and
accepting access to the second information from the user account of the owner.

7. The method of claim 1, further comprising:
storing third information regarding a record of payment by the user for bills; and
accepting access to the third information from the user account of the owner.

8. An information processing apparatus comprising a memory and a controller configured to:
bill a user of a vehicle parked in a space;
store first information indicating a status of payment of a bill amount by the user in the memory; and
accept access to the first information from a user account of an owner of the space.

9. The information processing apparatus of claim 8, wherein the controller is configured to:
determine, based on the first information, whether payment of the bill amount by the user is overdue; and
notify the owner, notify the user, and/or report to police when the payment of the bill amount by the user is determined to be overdue.

10. The information processing apparatus of claim 8, wherein the controller is configured to register, as a setting for the space, a first setting that permits parking in the space by vehicles, or a second setting that prohibits parking in the space by vehicles.

11. The information processing apparatus of claim 10, wherein the bill amount for the user differs depending on whether the setting for the space is the first setting or the second setting.

12. The information processing apparatus of claim 10, wherein the controller is configured to switch the setting for the space from one of the first setting and the second setting to the other in response to a request from the user account of the owner.

13. The information processing apparatus of claim 8, wherein the controller is configured to:
store, in the memory, second information regarding a record of parking by the user in a space where parking is prohibited; and
accept access to the second information from the user account of the owner.

14. The information processing apparatus of claim 8, wherein the controller is configured to:
store, in the memory, third information regarding a record of payment by the user for bills; and
accept access to the third information from the user account of the owner.

15. A non-transitory computer readable medium storing a program configured to cause a computer to execute operations, the operations comprising:
billing a user of a vehicle parked in a space;
storing first information indicating a status of payment of a bill amount by the user; and
accepting access to the first information from a user account of an owner of the space.

16. The medium of claim 15, wherein the program is configured to cause the computer to execute the operations further comprising:
determining, based on the first information, whether payment of the bill amount by the user is overdue; and
notifying the owner, notifying the user, and/or reporting to police when the payment of the bill amount by the user is determined to be overdue.

17. The medium of claim 15, wherein the program is configured to cause the computer to execute the operations further comprising registering, as a setting for the space, a first setting that permits parking in the space by vehicles, or a second setting that prohibits parking in the space by vehicles.

18. The medium of claim 17, wherein the bill amount for the user differs depending on whether the setting for the space is the first setting or the second setting.

19. The medium of claim 17, wherein the program is configured to cause the computer to execute the operations further comprising switching the setting for the space from one of the first setting and the second setting to the other in response to a request from the user account of the owner.

20. The medium of claim 15, wherein the program is configured to cause the computer to execute the operations further comprising:
storing second information regarding a record of parking by the user in a space where parking is prohibited and/or third information regarding a record of payment by the user for bills; and
accepting access to the second information and/or the third information from the user account of the owner.
